(19) United States
(12) Patent Application Publication
(10) Pub. No.: US 2022/0142160 A1
(43) Pub. Date: May 12, 2022

(54) METHOD OF INHIBITING OR REDUCING BIOFILM IN A PETROLEUM PRODUCTION PROCESS

(71) Applicant: KEMIRA OYJ, HELSINKI (FI)

(72) Inventors: Virginia TURK, Atlanta, GA (US); Wayne DICKINSON, Atlanta, GA (US); Luciana Residency, Atlanta, GA (US); Jaakko SIMELL, Helsinki (FI); Marko KOLARI, Helsinki (FI)

(21) Appl. No.: 17/434,444

(22) PCT Filed: Feb. 28, 2020
(86) PCT No.: PCT/US2020/020377

§ 371 Date: Aug. 27, 2021

Related U.S. Application Data
(60) Provisional application No. 62/811,561, filed on Feb. 28, 2019.

(30) Foreign Application Priority Data
Mar. 19, 2019 (FI) 20195203

(51) Int. Cl. A01N 41/10; C09K 8/524; A01N 43/78

(52) U.S. Cl. CPC A01N 41/10; A01N 43/78; C09K 8/524

(57) ABSTRACT

The present disclosure generally relates to relates to methods of controlling biofilm, e.g., biofilm comprising microorganisms such as bacteria, which methods inhibit the formation of and/or reduce the amount of biofilm on a petroleum production surface, by contacting the surface and/or the biofilm with a petroleum field fluid comprising at least one compound which controls or inhibits the formation of and/or reduces the amount of biofilm.

### RELATED APPLICATIONS

This application claims priority to U.S. Provisional Application No. 62/811,561, filed on Feb. 28, 2019; and to Finnish Application No. 20195203, filed on Mar. 19, 2019, the contents of which are incorporated by reference in their entirety.

### FIELD OF THE ART

The present disclosure generally relates to methods of controlling of biofilm, such as by inhibiting, reducing, and/or preventing formation of, and/or reducing an amount of, biofilm on a surface, such as a petroleum production surface.

### BACKGROUND

Microorganisms are present in many industrial processes, such as, for example, oil and gas industry processes. Microorganisms such as bacteria can cause formation of unwanted microbial biofilms during well drilling, preparation of the well for production, i.e., well stimulation, and during production itself. Formation of such biofilms, if untreated, can cause extensive problems in these and other oil and natural gas production processes.

Biofilm formation in oil field or gas field applications may, for example, cause increased risk for corrosion beneath the biofilm, or may plug rock pores or other conduits. Based on the foregoing, effective control and/or prevention of biofilm formation on process surfaces in production of oil and natural gas is desirable. Consequently, there is a need for improved means for biofilm control and/or reduction in biofilm formation in petroleum production processes.

### BRIEF SUMMARY

The present disclosure generally relates to a method of controlling biofilm such as by inhibiting a formation of, or reducing an amount of, biofilm on a surface, optionally a petroleum production surface, the method comprising contacting the surface and/or the biofilm with a petroleum field fluid comprising an effective amount of one or more compounds according to Formula (I):

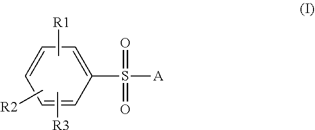

wherein: R1, R2 and R3 independently represent a hydrogen atom; halogen atom; hydroxy group; amino group; alkylamino group, alkyl group, hydroxyalkyl group, haloalkyl group or alkoxy group having 1 to 4 carbon atoms; or an acylamido group having 1 to 10 carbon atoms; and A represents 2-thiazolamine; 2-propenenitrile; 2-propenoic acid; alkyl ester or hydroxyalkyl ester of 2-propenoic acid having 1 to 4 carbon atoms; or a —CHCHCONR5R6 group, where R5 and R6 represent independently a hydrogen atom, or an alkyl or hydroxyalkyl having 1 to 4 carbon atoms; and further wherein the biofilm comprises microorganisms, optionally bacteria.

In some embodiments, the petroleum field fluid may comprise an aqueous fluid and/or the petroleum field fluid may comprise water. In some embodiment, regarding Formula (I): R1 may represent a methyl group; ethyl propyl group; butyl group; methoxy group; ethoxy group; propoxy group; isopropoxy group; n-butoxy group; or tertiary butoxy group; and R2 and R3 may represent independently a hydrogen atom; methyl group; ethyl propyl group; butyl group; methoxy group; ethoxy group; propoxy group; isopropoxy group; n-butoxy group; tertiary butoxy group; and A may represent 2-propenenitrile.

In some embodiments, regarding Formula (I): R1 may represent a methyl group; ethyl propyl group; butyl group; methoxy group; ethoxy group; propoxy group; isopropoxy group; n-butoxy group; tertiary butoxy group; or amino group; and R2 and R3 may represent independently a hydrogen atom; methyl group; ethyl propyl group; butyl group; methoxy group; ethoxy group; propoxy group; isopropoxy group; n-butoxy group; tertiary butoxy group; and A may represent a —CHCHCONR5R6 group, where R5 and R6 may represent independently a hydrogen atom; an alkyl or hydroxyalkyl having 1 to 4 carbon atoms; optionally wherein R5 and R6 represent hydrogen atoms.

In some embodiments, the compound according to Formula (I) may be 3-[(4-methylphenyl)sulphonyl]-2-propenenitrile or 4-amino-N-2-thiazolyl-benzenesulphonamide. In some embodiments, the compound according to Formula (I) may be selected from group consisting of 3-phenylsulphonyl-2-propenenitrile, 3-[(4-fluorophenyl)sulphonyl]-2-propenenitrile, 3-[(4-trifluoromethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4,6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)-sulphonyl]prop-2-enoic acid, and any of their isomers.

In some embodiments, the petroleum field fluid may comprise at least one compound according to Formula (I) in an amount ranging from 0.01-100 ppm, 0.01-25 ppm, or 0.01-15 ppm. In some embodiments, the petroleum field fluid may comprise at least one compound according to Formula (I) in an amount ranging from 0.01-10 ppm, 0.01-2 ppm, or 0.1-2 ppm. In some embodiments, the microorganisms may comprise acid-producing bacteria (APB), sulphate-reducing bacteria (SRB) and/or general heterotrophic bacteria (GHB). In some embodiments, the petroleum field fluid may be selected from the group consisting of a stimulation fluid, squeeze fluid, fracturing fluid, drilling mud, workover or completion fluid, hydrotest fluid, and an injection fluid for reservoir maintenance or Enhanced Oil Recovery (EOR). In some embodiments, the temperature of the petroleum field fluid may be at least 30° C., at least 40° C., or at least 50° C. In some embodiments, the petroleum field fluid may comprise hydrocarbons selected from the group consisting of alkenes, alkanes, arenes, heteroaromatic molecules and any mixtures thereof. In some embodiments, the petroleum field fluid may comprise one or more chemical additives, optionally at least one chemical additive that is a water-soluble polymer. In some embodiments, the petroleum field fluid further may comprise at least one biocide, antimicrobial agent, or any combination thereof, optionally wherein the biocide and/or antimicrobial agent is selected from the group consisting of glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CMIT), and 2-methyl-4-isothiazolin-3-one (MIT), chlorine, salts of hypochlorite, hypochlorous acid, chlorinated isocyanurates, bromine, salts of hypobromite, hypobromous acid, bromine chloride, chlorine dioxide, ozone, hydrogen peroxide, and peroxy compounds, such as peracetic acid or performic acid. In some embodiments, said one or more compounds may not act as biocidal agents.

### DETAILED DESCRIPTION

### Definitions

As used herein the singular forms “a”, “an”, and “the” include plural referents unless the context clearly dictates otherwise. All technical and scientific teams used herein have the same meaning as commonly understood to one of ordinary skill in the art to which this invention belongs unless clearly indicated otherwise.

As used herein, the term “petroleum production surface” generally refers to any surface upon which biofilm may form during an industrial process, such as oil and/or gas processes. Such surfaces include, but are not limited to, rock, such as a petroleum formation or drilling well, concrete, metal, and plastic. In some embodiments, the petroleum production surface comprises a surface that is in contact with oil or gas or is adapted to contact produced oil or gas during a process to extract petroleum. For example, the petroleum production surface can be the surface of a tank, a pipe, a well, or a rock formation.

As used herein, the term “petroleum field fluid” generally refers to any fluid, preferably liquid, used or present in an industrial process to extract petroleum from the ground. It is noted that petroleum generally refers to a mixture of hydrocarbons in liquid, gaseous or solid form. In some instances, the petroleum field fluid comprises an aqueous fluid. In some embodiments, the petroleum field fluid comprises water. In some embodiments, the petroleum field fluid comprises at least 10 weight-%, at least 30 weight-%, at least 50 weight-%, at least 70 weight-%, at least 90 weight-%, or more, of an aqueous fluid, such as, for example, water. In some embodiments, the petroleum field fluid may comprise a stimulation fluid, squeeze fluid, fracturing fluid, drilling mud, workover or completion fluid, hydrotest fluid, or an injection fluid for reservoir maintenance and Enhanced Oil Recovery (EOR), hydraulic fracturing fluids, and the like.

In some embodiments, the temperature of the petroleum field fluid may be at least 30° C., at least 40° C., or at least 50° C. The pH of the fluid may be in the range 5-9, e.g., 7-8.5. The petroleum field fluid may comprise hydrocarbon(s), such as, for example, alkenes, alkanes, arenes, heteroaromatic molecules and any mixtures thereof.

Furthermore, in some instances, the petroleum field fluid may optionally further comprise one or more chemical additives. For example, chemical additive(s) may include, but are not limited to, oils, salts (including organic salts), crosslinkers, polymers, biocides, corrosion inhibitors and dissolvers, enzymes, pH modifiers (e.g., acids and bases), breakers, metal chelators, metal complexing agents, antioxidants, oxygen scavengers, wetting agents, polymer stabilizers, clay stabilizers, scale inhibitors and dissolvers, wax inhibitors and dissolvers, asphaltene precipitation inhibitors, water flow inhibitors, fluid loss additives, chemical grouts, diverters, sand consolidation chemicals, proppants, permeability modifiers, viscoelastic fluids, gases (e.g., nitrogen and carbon dioxide), foaming agents and defoaming agents.

In some embodiments the petroleum field fluid may comprise one or more chemical additives, such as, for example, a polymer, e.g., a water-soluble polymer. In some embodiments, the polymer may be any polymer used in a petroleum field fluid, for example, a friction reducing polymer or a well-treatment polymer. The polymer may comprise any one or more of a polysaccharide, such as a galactomannan polymer, e.g. guar gum; a derivatized galactomannan polymer; starch; xanthan gum; a derivatized cellulose, e.g. hydroxycellulose or hydroxyalkyl cellulose; a polyvinyl alcohol polymer; a synthetic polymer obtained by polymerization of one or more monomers comprising vinyl pyrrolidone, 2-acrylamido-2-methylpropanesulfonic acid, acrylic acid, (meth)acrylic acid, styrene sulfonic acid, (meth)acrylamide. In some instances, the polymer comprises one or more polymers comprising acrylamide-based polymers, hydrolyzed polyacrylamide, guar gum, hydroxypropyl guar gum, carboxymethyl guar gum, carboxymethylhydroxypropyl guar gum, hydroxyethyl cellulose, carboxymethylhydroxyethyl cellulose, hydroxypropyl cellulose, copolymers of acrylic acid and/or acrylamide, xanthan, starches, and mixtures thereof. In some instances, the polymer comprises a copolymer of acrylic acid and acrylamide.

As used herein, the terms “controlling of biofilm”, “controlling biofilm”, and the like, generally encompasses various control actions selected at least from inhibiting, reducing, and/or preventing formation of, and/or reducing an amount of, biofilm. These control actions may take place before, during, and/or after biofilm formation and the control actions may take place separately or simultaneously. For example, controlling of biofilm may comprise use of one or more compounds according to Formula (I), which may both inhibit or prevent formation of new biofilm and simultaneously reduce the amount, thickness, etc. of any existing biofilm. In some instances, the compound may function as a bio-dispersant, which reduces the amount of and/or inhibits the accumulation of biofilm on the surfaces, such as petroleum production surfaces. In some instances, controlling of biofilm may be effected by use of a compound according to Formula (I) infra in inhibiting or preventing the formation of biofilm on petroleum production surfaces. In general, the compound may inhibit or prevent formation of biofilm on biofilm-free process surfaces and/or may reduce the amount of biofilm on said surfaces, such as reduction of the amount of existing biofilm on said surface.

As used herein, the term “biofilm” generally refers to a community of microorganisms, typically bacteria, which adheres to a process surface, e.g. a petroleum production surface, which usually grows surrounded by a complex matrix of extracellular polymeric substances (“EPS”). The biofilm can protect the microorganisms, which therefore may present challenges in the control of the biofilm. Ineffective biofilm control may contribute to difficulties in processes of the petroleum industry, for example, in the form of increased corrosion, production stops and/or deterioration of production quality and/or quantity which may result from the presence of biofilm.

### Methods and Compositions

The present disclosure generally relates to a method of controlling biofilm, such as by inhibiting the formation of, or reducing an amount of, a biofilm on a surface, e.g., a petroleum production surface. Methods described herein generally provide for effective control of biofilm, e.g., prevention, inhibition, and/or reduction of biofilm formation, and such effects can generally be achieved with compositions described herein, in such industrial processes as petroleum field fluid processes, e.g., oil field fluid or gas field fluid processes. Moreover, the presently described methods generally inhibit, prevent, and/or reduce biofilm formation at high temperatures, e.g., in aqueous process conditions with at least locally high shear forces, elevated pressure and/or high flow rates. As described herein and further demonstrated by the working examples, the methods and compositions described herein which comprise compounds according to Formula (I) below outperformed conventional chemical agents used against biofilms in the petroleum industry.

In some embodiments, said method comprises contacting the surface and/or the biofilm with a petroleum field fluid comprising a compound according to Formula I:

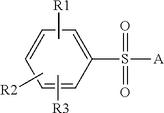

wherein:

R1, R2 and R3 independently represent a hydrogen atom; halogen atom; hydroxy group; amino group; alkylamino group, alkyl group, hydroxyalkyl group, haloalkyl group or alkoxy group having 1 to 4 carbon atoms; or an acylamido group having 1 to 10 carbon atoms; and A represents 2-thiazolamine; 2-propenenitrile; 2-propenoic acid; alkyl ester or hydroxyalkyl ester of 2-propenoic acid having 1 to 4 carbon atoms; or a —CHCHCONR5R6 group, where R5 and R6 represent independently a hydrogen atom, or an alkyl or hydroxyalkyl having 1 to 4 carbon atoms; and further wherein the biofilm comprises microorganisms, such as, for example, bacteria.

In some embodiments, said method comprises contacting the surface and/or biofilm with at least one compound according to Formula (I) in an amount effective to inhibit, reduce, and/or prevent formation of biofilm and/or reduce the amount of biofilm on the surface, e.g., petroleum production surface.

In some embodiments, the method of treating the surface comprises treating said surface with one or more compounds according to Formula (I), wherein said one or more compounds inhibit the formation of, or reduce the amount of, a biofilm on the surface, e.g., petroleum production surface, further wherein said one or more compounds do not act as a biocide or biostat, i.e., said one or more compounds effectively reduce the amount of and/or inhibit the formation of one or more extracellular polymeric species (“EPS”) in the system, such as may be measured by a reduction in biofilm biomass as compared to a control with either no compound or a biocidal compound, wherein said one or more compounds according to Formula (I) do not kill the microorganisms in the system. In some instances, said one or more compounds may act as bio-dispersants, such as to inhibit the formation of, or reduce the amount of, a biofilm on a surface without acting as a biocide or biostat. In some instances, lack of a biocidal effect is desired, such as due to environmental and/or biome considerations of the surface. In some embodiments, said method comprising use of one or more compounds according to Formula (I) may result in a decrease in biofilm biomass and, also in an increase in number of bacteria as may be measured by bacterial counts.

In some embodiments, the R1 group of the compound according to the Formula (I) represents a methyl group; ethyl propyl group; butyl group; methoxy group; ethoxy group; propoxy group; isopropoxy group; n-butoxy group; or tertiary butoxy group; and/or R2 and/or R3 represent independently hydrogen atom; methyl group; ethyl propyl group; butyl group; methoxy group; ethoxy group; propoxy group; isopropoxy group; n-butoxy group; tertiary butoxy group; and/or A represents 2-propenenitrile; and/or R1, R2, R3 may be located independently in ortho, meta or para position in relation to the substituent group comprising A. Such compounds may be used to effectively inhibit and/or reduce the formation of biofilm on a surface.

In some embodiments the R1 group of the compound according to Formula (I) represents a methyl group; ethyl propyl group; butyl group; methoxy group; ethoxy group; propoxy group; isopropoxy group; n-butoxy group; tertiary butoxy group; or amino group; and/or R2 and/or R3 represent independently hydrogen atom; methyl group; ethyl propyl group; butyl group; methoxy group; ethoxy group; propoxy group; isopropoxy group; n-butoxy group; tertiary butoxy group; and/or A represents —CHCHCONR5R6 group, where R5 and R6 represent independently hydrogen atom; alkyl or hydroxyalkyl having 1 to 4 carbon atoms; preferably R5 and R6 representing hydrogen atoms; and R1, R2, R3 may be located independently in ortho, meta or para position relative to the substituent group comprising A. Such compounds may be used to effectively inhibit and/or reduce the formation of biofilm on a surface.

In some instances, when R1, R2 or R3 is haloalkyl, it may be trifluoromethyl.

In some embodiments, the compositions used in the methods described herein may comprise a compound according to Formula (I), which may be selected from a group consisting of 3-phenylsulphonyl-2-propenenitrile, 3-[(4-fluorophenyl)sulphonyl]-2-propene-nitrile, 3-[(2,4-dimethylphenyl)sulphonyl]-2-propenenitrile, 3-[(4-trifluoromethylphenyl)-sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4,6-trimethylphenyl)sulphonyl]-2-propenenitrile, 3-(4-methoxyphenyl)sulphonyl-2-propenenitrile, (3-[(4-methyl-phenyl)sulphonyl]prop-2-enamide, 3-[(4-methylphenyl)sulphonyl]prop-2-enoic acid, and any of their isomers. In some embodiments, the compound according to Formula (I) is selected from a group consisting of 3-phenylsulphonyl-2-propenenitrile; 3-[(4-trifluoromethylphenyl)-sulphonyl]-2-propenenitrile; 3-[(2,4,6-trimethylphenyl)sulphonyl]-2-propenenitrile; 3-(4-methoxyphenyl)sulphonyl-2-propenenitrile; 3-[(4-methylphenyl)sulphonyl]prop-2-enamide; and any of their isomers.

In some embodiments, the compositions used in the methods described herein may comprise 3-[(4-methylphenyl)sulphonyl]-2-propenenitrile or 4-amino-N-2-thiazolyl-benzene-sulphonamide, even more preferably 3-[(4-methylphenyl)sulphonyl]-2-propenenitrile.

In some embodiments, the petroleum field fluid may comprise compound(s) according to Formula (I) in form of a Z- or E-isomer, or the petroleum field fluid may comprise these compounds as a mixture of both isomers. For example, the ratio of E to Z isomers in the petroleum field fluid may be from 70:30 to 100:0 or from 80:20 to 99:1. Alternatively the ratio of E to Z isomers in the petroleum field fluid may be from 30:70 to 0:100 or from 20:80 to 1:99.

In some embodiments, the methods described herein may be suitable for inhibiting, reducing and/or controlling the biofilm, e.g., the formation of biofilm, caused by any microorganisms commonly found in oil and gas production environments. In some embodiments, the microorganisms may comprise acid-producing bacteria (APB), sulphate-reducing bacteria (SRB), and/or general heterotrophic bacteria (GHB). In some embodiments, the bacteria may belong to genera of Desulfovibrio, Desulfotomaculum, Clostridium and/or Citrobacter.

In some embodiments, the petroleum field fluid may comprise a compound according to Formula (I) in any effective amount that is sufficient to at least control and/or prevent and/or reduce the biofilm formation on a petroleum production surface, when the said surface and/or biofilm is contacted with the petroleum field fluid. In some embodiments, the petroleum field fluid may comprise the compound according to Formula (I) in an amount ranging from 0.01-100 ppm, 0.01-25 ppm, 0.01-15 ppm or 0.01-10 ppm, 0.01-2 ppm, 0.1-2 ppm, or 0.1-1 ppm. As demonstrated by the working examples, effective control of biofilm can be achieved using low dosages of compounds according to Formula (I).

In some embodiments, compounds according to Formula (I) may be added to the petroleum field fluid as a solid, such as dry powder, and/or in a liquid form. In some embodiments, the compound according to Formula (I) may be dissolved into a suitable solvent, in some instances an organic solvent, such as propylene carbonate, and added to the petroleum field fluid. In some instances, the compound may be dissolved directly into the petroleum field fluid. In some embodiments, the compound may be dosed continuously or periodically.

In some embodiments, the petroleum field fluid may comprise one or more compounds according to Formula (I). In instances wherein the petroleum field fluid comprises more than one compound according to Formula (I), the compounds may be added to the petroleum field fluid as one composition, i.e., as a mixture, or they may be added separately, either simultaneously or successively after each other. In instances when more than one compound according to Formula (I) is added, the individual amounts for each compound may be the same or different from each other. In some instances, use of more than one compound according to Formula (I) be used to effectively inhibit and/or reduce the formation of biofilm on a surface.

In some embodiments, the petroleum field fluid may comprise one or more compounds according to Formula (I) and may be suitable for use in well stimulation applications, tank storage systems and/or water-cooling towers.

In some embodiments, the petroleum field fluid is a well-injection fluid. In some embodiments, the well-injection fluid may be used to remove a production fluid, such as oil, from a subterranean formation. The well-injection fluid may be any fluid suitable for forcing the production fluid out of the subterranean formation and into a production wellbore where it can be recovered. For example, the well-injection fluid may comprise an aqueous fluid such as fresh water or salt water (i.e., water containing one or more salts dissolved therein), e.g., brine (i.e., saturated salt water), or seawater. In some embodiments the well-injection fluid may be used in a flooding operation (e.g., secondary flooding as opposed to a primary recovery operation which relies on natural forces to move the fluid) to recover a production fluid, e.g., oil, from a subterranean formation. The flooding operation may entail displacing the well-injection fluid through an injection well (or wells) down to the subterranean formation to force or drive the production fluid from the subterranean formation to a production well (or wells). The flooding may be repeated to increase the amount of production fluid recovered from the reservoir.

In some embodiments, the compound according to Formula (I) may be used in combination with one or more biocidal or antimicrobial agents, and the petroleum field fluid may further comprise at least one biocide, an antimicrobial agent, or any combination thereof. Suitable biocides or antimicrobial agents can be non-oxidizing biocides or antimicrobial agents, or oxidizing biocides or antimicrobial agents. Suitable non-oxidizing biocides or antimicrobial agents are, for example, glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CMIT), and 2-methyl-4-isothiazolin-3-one (MIT). Suitable oxidizing biocides or antimicrobial agents are, for example, chlorine, salts of hypochlorite, hypochlorous acid, chlorinated isocyanurates, bromine, salts of hypobromite, hypobromous acid, bromine chloride, chlorine dioxide, ozone, hydrogen peroxide, and peroxy compounds, such as peracetic acid or performic acid. Other suitable oxidizing biocides are, for example, stabilized halogen compounds wherein active halogen, such as chlorine or bromine is reacted with a nitrogenous compound, such as dimethylhydantontoin, an ammonium salt, urea, carbamate, or another nitrogen containing molecule capable of reacting with active halogen. For example, in some embodiments the compound according to Formula (I) may be added to an aqueous environment, which comprises a residual of active halogen in the range from about 0.01 to about 20 ppm, given as active chlorine.

The compositions and methods illustratively disclosed herein suitably may be practiced in the absence of any element which is not specifically disclosed herein and/or any element specifically disclosed herein.

### EXAMPLES

Materials and Methods

A mixed culture of oil field bacteria with Sulphate Reducing Bacteria (SRB), Acid Producing Bacteria (APB), and General Heterotrophic Bacteria (GHB) that came from an oil field system and had been frozen in glycerol maintained at −80° C. was used to study the effect of the test chemical compounds on biofilm formation and control thereof.

Biofilm tests were performed in 3.5 weight-% nutrient brine (NB) solution with minimal nutrients and a mixture of dodecane isomers, which are customary in oil field production waters and storage tanks.

The oilfield bacteria consortia was inoculated into the 3.5 weight-% nutrient brine solution and allowed to acclimate overnight at 32° C. in bulk. After acclimation, the solution was divided into 250 mL Pyrex bottles to contain 200 mL of the inoculated 3.5 weight-% nutrient brine and 25 mL of dodecane. Biofilms were grown on glass slides as removable attachment surfaces. Bottles were incubated at 32° C. with a rotary shaking (75 rpm) providing medium flow in each container.

3-[(4-methylphenyl)sulfonyl]-2-propenenitrile, hereinafter called Compound A, was obtained from EMD Biosciences Inc, USA; purity ≥98% E-isomer.

Tetrahydro-3,5-dimethyl-2H-1,3,5-thiadiazine-2-thione, hereinafter called AMA-324, was obtained from Kemira Oyj (24% active ingredient).

Test Method for Bacterial Growth Control

Reactors each containing 200 mL of 3.5% nutrient brine were inoculated with the oilfield bacterial consortia and 25 mL of dodecane was treated with different amounts of the chemical compounds to be tested. A nitrogen blanket was added to the top of each reactor to minimize the oxygen content and allow a beneficial environment for anaerobic bacterial growth. After 24 hours, test chemical compounds were added to the respective reactors again and the nitrogen blanket was reapplied. This was done daily for 5 days. After an additional 24 hours, i.e. 6 days after starting the test, samples were pulled for planktonic and sessile bacterial counts. Each test was conducted in triplicate.

Test Method for Control of Biofilm

Two glass slides were added to each reactor bottle as described above and below and were removed at the end of the 6-day test for observation of biofilm accumulation, with the following considerations. For biofilm control experiments comprising biofilm removal from glass slides in 3.5% nutrient brine media inoculated with the mixed oilfield bacterial cultures and dodecane, biofilm was grown without addition of any test chemical compound to be tested in the control. In the reactors containing the test chemical compound, they were re-dosed daily for 5 days. A nitrogen blanket was added to each reactor after each dosing.

After an additional 24 hours from the 5-day dosing or 6 days, the slides were removed from the reactors using sterile forceps. Each glass slide was rinsed with sterile phosphate buffer solution and scraped at a designated section of 1 cm² with a sterile wooden stick. The removed biofilm was scraped into 9 mL of phosphate buffer for enumeration.

Quantification of Formed Biofilm

As described above, two glass slides were added to each reactor bottle. One was used for bacterial counts and the second was used to observe for biofilm accumulation. The second glass slide used to observe for growth was rinsed with deionized water, dried for 20 hours at 70° C., weighed and photographed. The weight values shown in the following tables are weights from 3 replicate reactor bottles. All weight values are given as actual measured values of the glass slides.

### Example 1

Table 1 below shows the treatment strategies of Example 1, and Table 2 presents results demonstrating that Compound A lacks biocidal activity in conditions comprising the mixed oilfield bacterial consortia and an anaerobic environment. Test conditions simulated harsh oilfield systems conditions (high brine nutrients, high temperature, oil and gas components, flow). Table 2 presents the effect on bacterial counts of the Compound A and AMA-324 dosing on the mixed oilfield consortia in 3.5% nutrient brine with dodecane at 32° C. and 75 rpm. The treatment compound was dosed daily for 5 days. Both planktonic bacterial counts and sessile bacterial counts were recorded and are shown in Table 2.

The results of Table 2 demonstrate that Compound A did not act as a biocidal agent. For comparison, the conventional antimicrobial agent AMA-324 at a dosage of 75 ppm active ingredient alone acted as a biocide as evidenced by the bacterial counts as compared to the control and to the Compound A treated samples. It was further observed that the lack of biocidal effects of Compound A occurred over a dosage range of 1 ppm to 5 ppm.

TABLE 1
Treatment strategy used in the experiments

| | |
|---|---|
| Sample ID | Treatment Strategy |

| | | |
|---|---|---|
| 0 | ppm | 3.5% NB with oilfield bacteria |

(reference)

| | | |
|---|---|---|
| 1.0 | ppm | 3.5% NB with oilfield bacteria + 1.0 ppm |
| | | Compound A |
| 2.0 | ppm | 3.5% NB with oilfield bacteria + 2.0 ppm |
| | | Compound A |
| 5.0 | ppm | 3.5% NB with oilfield bacteria + 5.0 ppm |
| | | Compound A |
| 75 | ppm | 3.5% NB with oilfield bacteria + 75 ppm |

| | |
|---|---|
| (reference) | A-324 |

| | | |
|---|---|---|
| 5 + 75 | ppm | 3.5% NB with oilfield bacteria + 5.0 ppm |
| | | Compound A + 75 ppm A-324 |

TABLE 2
Results for Example 1

| | Planktonic Bacterial Counts/mL | | | Sessile Bacterial Counts/mL | | |
|---|---|---|---|---|---|---|
| Sample | SRB | APB | GHB | SRB | APB | GHB |
| ID | bacteria | bacteria | bacteria | bacterial | bacterial | bacteria |
| 0 ppm | 4.00E−01 | 2.50E+01 | 4.50E+01 | 5.00E+02 | 8.00E+00 | 5.00E+01 |
| (reference) | 4.50E+00 | 9.50E+01 | 1.10E+03 | 1.90E+03 | 4.00E+01 | 1.50E+03 |
| | 4.50E+00 | 1.50E+02 | 2.00E+03 | 4.00E+01 | 1.40E+01 | 2.20E+02 |
| 1 ppm | 2.50E+01 | 3.00E−01 | 3.00E−01 | 2.00E+01 | <0.6 | <0.6 |
| | 1.10E+07 | 4.50E+04 | 4.50E+04 | 4.00E+06 | 9.00E+04 | 9.00E+04 |
| | 9.00E−01 | 4.00E−01 | 4.00E−01 | 6.00E+00 | <0.6 | <0.6 |
| 2 ppm | 1.40E+07 | 9.50E+03 | 9.50E+03 | 1.90E+07 | 9.00E+04 | 9.00E+04 |
| | 4.50E+06 | 9.50E+01 | 2.50E+02 | 9.00E+06 | 2.20E+02 | 2.20E+02 |
| | 1.40E+07 | 9.50E+04 | 9.50E+04 | 5.00E+07 | 3.00E+05 | 3.00E+05 |
| 5 ppm | 1.40E+07 | 2.50E+03 | 2.50E+03 | 1.90E+07 | 1.90E+04 | 1.90E+04 |
| | 1.10E+07 | 4.50E+01 | 4.50E+01 | 1.90E+07 | 5.00E+01 | 5.00E+01 |
| | 1.40E+06 | 2.50E+04 | 2.50E+04 | 1.90E+07 | 9.00E+03 | 9.00E+03 |
| 75 ppm | <0.3 | <0.3 | <0.3 | <0.6 | 8.00E+00 | 8.00E+00 |
| (reference) | <0.3 | <0.3 | <0.3 | <0.6 | <0.6 | <0.6 |
| | <0.3 | <0.3 | <0.3 | <0.6 | <0.6 | <0.6 |
| 5 + 75 ppm | <0.3 | <0.3 | <0.3 | <0.6 | <0.6 | <0.6 |
| | <0.3 | <0.3 | <0.3 | <0.6 | <0.6 | <0.6 |
| | <0.3 | <0.3 | <0.3 | <0.6 | <0.6 | <0.6 |

### Example 2

Table 3 presents results related to the effect on biofilm biomass of Compound A and AMA-324 dosing on the mixed oilfield consortia in 3.5 weight-% nutrient brine with dodecane at 32° C. and 75 rpm. Compound A was dosed daily for 5 days. AMA-324 was dosed at initial set-up only. Two glass slides were each weighed and added to each test container at set-up. After dosing for 5 days, at day 6, the slides were removed for analysis. Slide A was dried and weighed without further manipulation. Slide B was scrapped at 1 cm² with a sterile wooden stick into sterile phosphate buffer solution for bacterial counts. The scraped glass slide was then dried and weighed.

TABLE 3
Results of Example 2

| | | | |
|---|---|---|---|
| | Slide A | Slide B | average weight |
| | weight | weight | gain of Slides |
| Sample ID | gain, mg | gain, mg | A and B |

| | | | | |
|---|---|---|---|---|
| 0 | ppm | 0.05 | −0.45 | −0.20 |

| | | | |
|---|---|---|---|
| (reference) | 0.8 | 1.1 | 0.95 |

| | | | | |
|---|---|---|---|---|
| | | 0.85 | 1.25 | 1.05 |
| 1 | ppm | 0.25 | 0.5 | 0.38 |
| | | 0.3 | 0.15 | 0.22 |
| | | 0.6 | 0.55 | 0.57 |
| 2 | ppm | 0.3 | 0.15 | 0.22 |
| | | 0.6 | 0.2 | 0.40 |
| | | 0.1 | 0.3 | 0.20 |
| 5 | ppm | 0.7 | 0.6 | 0.65 |
| | | 0.75 | 0.25 | 0.50 |
| | | 0.85 | 0.9 | 0.88 |
| 75 | ppm | 1.35 | 1.85 | 1.60 |

| | | | |
|---|---|---|---|
| (reference) | 1.95 | 2.15 | 2.05 |

| | | | | |
|---|---|---|---|---|
| | | 1.6 | 2.1 | 1.85 |
| 5 + 75 | ppm | 1.05 | 1.35 | 1.20 |
| | | 1.05 | 1.15 | 1.10 |
| | | 1.3 | 1.1 | 1.20 |

It can be seen from the results of Table 3 that Compound A very effectively reduced biofilm formation. More particularly, the results presented in Table 3 demonstrate that Compound A effectively controlled biofilm formation as the weight of slides treated with Compound A were consistently less than that of the control or of the slides treated with AMA-324. The results of Table 3 demonstrated that Compound A was effective at decreasing the amount of biofilm biomass. The results of Table 3 are consistent with optical density measurements which similarly showed that Compound A decreased the amount of biofilm biomass (data not shown).

In the preceding procedures, various steps have been described. It will, however, be evident that various modifications and changes may be made thereto, and additional procedures may be implemented, without departing from the broader scope of the exemplary procedures as set forth in the claims that follow.

1. A method of controlling biofilm such as by inhibiting a formation of, or reducing an amount of, biofilm on a surface, optionally a petroleum production surface, the method comprising contacting the surface and/or the biofilm with a petroleum field fluid comprising an effective amount of one or more compounds according to Formula (I): 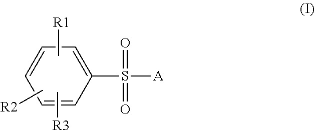
wherein:
R1, R2 and R3 independently represent a hydrogen atom; halogen atom; hydroxy group; amino group; alkylamino group, alkyl group, hydroxyalkyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or a —CHCHCONR5R6 group, where R5 and R6 represent independently a hydrogen atom, or an alkyl or hydroxyalkyl having 1 to 4 carbon atoms; and
further wherein the biofilm comprises microorganisms, optionally bacteria.

2. The method according to claim 1, wherein the petroleum field fluid comprises an aqueous fluid and/or the petroleum field fluid comprises water.

3. The method according to claim 1 or 2, wherein Formula (I):
R1 represents methyl group; ethyl propyl group; butyl group; methoxy group; ethoxy group; propoxy group; isopropoxy group; n-butoxy group; or tertiary butoxy group; and
R2 and R3 represent independently hydrogen atom; methyl group; ethyl propyl group; butyl group; methoxy group; ethoxy group; propoxy group; isopropoxy group; n-butoxy group; tertiary butoxy group; and
A represents 2-propenenitrile

4. The method according to any one of the foregoing claims, wherein Formula (I):
R1 represents methyl group; ethyl propyl group; butyl group; methoxy group; ethoxy group; propoxy group; isopropoxy group; n-butoxy group; tertiary butoxy group; or amino group; and
R2 and R3 represent independently hydrogen atom; methyl group; ethyl propyl group; butyl group; methoxy group; ethoxy group; propoxy group; isopropoxy group; n-butoxy group; tertiary butoxy group; and
A represents a —CHCHCONR5R6 group, where R5 and R6 represent independently a hydrogen atom; an alkyl or hydroxyalkyl having 1 to 4 carbon atoms; optionally wherein R5 and R6 represent hydrogen atoms.

5. The method according to any one of the foregoing claims, wherein the compound according to Formula (I) is 3-[(4-methylphenyl)sulphonyl]-2-propenenitrile or 4-amino-N-2-thiazolyl-benzenesulphonamide.

6. The method according to any one of the foregoing claims, wherein the compound according to Formula (I) is selected from group consisting of 3-phenylsulphonyl-2-propenenitrile, 3-[(4-fluorophenyl)sulphonyl]-2-propenenitrile, 3-[(4-trifluormethyl-phenyl)sulphonyl]-2-propenenitrile, 3-[(2,4-dimethylphenyl)sulphonyl]-2-propene-nitrile, 3-[(3,4-dimethylphenyl)sulphonyl]2-propenenitrile, 3-(3,5-dimethylphenyl)-sulphonyl-2-propenenitrile, 3-[(2,4,6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers.

7. The method according to any one of the foregoing claims, wherein the petroleum field fluid comprises at least one compound according to Formula (I) in an amount ranging from 0.01-100 ppm, 0.01-25 ppm, or 0.01-15 ppm.

8. The method according to any of the foregoing claims, wherein the petroleum field fluid comprises at least one compound according to Formula (I) in an amount ranging from 0.01-10 ppm, 0.01-2 ppm, or 0.1-2 ppm.

9. The method according to any one of the foregoing claims, wherein the microorganisms comprise acid-producing bacteria (APB), sulphate-reducing bacteria (SRB) and/or general heterotrophic bacteria (GHB).

10. The method according to any one of the foregoing claims, wherein the petroleum field fluid is selected from the group consisting of a stimulation fluid, squeeze fluid, fracturing fluid, drilling mud, workover or completion fluid, hydrotest fluid, and an injection fluid for reservoir maintenance or Enhanced Oil Recovery (EOR).

11. The method according to any one of the foregoing claims, wherein the temperature of the petroleum field fluid is at least 30° C., at least 40° C., or at least 50° C.

12. The method according to any one of the foregoing claims, wherein the petroleum field fluid comprises hydrocarbons selected from the group consisting of alkenes, alkanes, arenes, heteroaromatic molecules and any mixtures thereof.

13. The method according to any one of the foregoing claims, wherein the petroleum field fluid comprises one or more chemical additives, optionally at least one chemical additive that is a water-soluble polymer.

14. The method according to any one of the foregoing claims, wherein the petroleum field fluid further comprises at least one biocide, antimicrobial agent, or any combination thereof, optionally wherein the biocide and/or antimicrobial agent is selected from the group consisting of glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CMIT), and 2-methyl-4-isothiazolin-3-one (MIT), chlorine, salts of hypochlorite, hypochlorous acid, chlorinated isocyanurates, bromine, salts of hypobromite, hypobromous acid, bromine chloride, chlorine dioxide, ozone, hydrogen peroxide, and peroxy compounds, such as peracetic acid or performic acid.

15. The method according to any one of the foregoing claims, wherein said one or more compounds do not act as biocidal agents.
